(19) United States
(12) Patent Application Publication
(10) Pub. No.: US 2025/0139362 A1
(43) Pub. Date: May 1, 2025

(54) TEXT GENERATION SUPPORT APPARATUS, TEXT GENERATION SUPPORT METHOD, AND PROGRAM

(71) Applicant: NIPPON TELEGRAPH AND TELEPHONE CORPORATION, Tokyo (JP)

(72) Inventors: Akira TAKEUCHI, Tokyo (JP); Masahiro SOTOMA, Tokyo (JP); Minako HARA, Tokyo (JP)

(21) Appl. No.: 18/681,251

(22) PCT Filed: Sep. 1, 2021
(86) PCT No.: PCT/JP2021/032194

§ 371 Date: Feb. 5, 2024

(51) Int. Cl. G06F 40/268

(52) U.S. Cl. CPC G06F 40/268

(57) ABSTRACT

In recent years, high performance can be obtained for tasks such as document classification, translation, summarization, and Q&A, but AI alone is insufficient in terms of generating sentences, and it can be said that it is a high demand for AI to support people. An object of the present invention is to support generation of a document by generating a new sentence by supporting an idea of a person.

According to the present invention, a document generation supporting device that supports generation of a document includes: a morpheme analysis unit 12 that performs morpheme analysis on data of the document and dividing the document into words; a mask word setting unit 13 that sets a mask word by masking a predetermined word among the divided words; and a word search unit 14 that uses a trained natural language processing model 2 to search for a likelihood in consideration of a word possibility and a context based on the mask word, and determines a substitute possibility for the mask word in accordance with the likelihood to complete a document possibility.

### TECHNICAL FIELD

The present disclosure content relates to a document generation supporting device, a document generation supporting method, and a program.

### BACKGROUND ART

In recent years, artificial intelligence (AI) and machine learning technologies have attracted attention in fields of supporting people. For example, the technology disclosed in Patent Literature 1 supports generation of a document representing a problem that a person wants to solve.

On the other hand, in order for a computer to mechanically process a document, there is a scheme of expressing words as embedding vectors using a neural network (for example, Word2vec). Furthermore, as a language model in consideration of a context, there is, for example, bidirectional encoder representations from transformers (BERT), and a general-purpose pre-trained language model is acquired using a large amount of text data, and fine tuning is performed on various natural language tasks, so that high performance can be obtained.

### CITATION LIST

### Patent Literature

Patent Literature 1: JP 2020-042695 A

### SUMMARY OF INVENTION

### Technical Problem

However, high performance can be obtained for tasks such as document classification, translation, summarization, and Q&A, but AI alone is insufficient in terms of generating sentences, and it can be said that it is a high demand for AI to support people.

The present invention has been made in view of the foregoing circumstances, and an object of the present invention is to support generation of a document by generating a new sentence by supporting an idea of a person.

### Solution to Problem

In order to solve the above problem, an invention according to claim 1 is a document generation supporting device that supports generation of a document, the device including: a morpheme analysis means that performs morpheme analysis on data of the document and divides the document into words; a mask word setting means that sets a mask word by performing masking on a predetermined word among the divided words; and a word search means that searches for a likelihood in consideration of a word possibility and a context based on the mask word using a trained natural language processing model, and determines a substitute possibility for the mask word in accordance with the likelihood, thereby completing the document possibility.

### Advantageous Effects of Invention

As described above, according to the present invention, the document generation supporting device 1 determines a substitute possibility for a word of an input document to support the idea of a person and generate a new document, so that the generation of the document can be supported.

### BRIEF DESCRIPTION OF DRAWINGS

FIG. 1 is an electrical hardware configuration diagram illustrating a document generation supporting device according to an embodiment.

FIG. 2 is a functional block diagram illustrating a document generation supporting device according to the embodiment.

FIG. 3 is a flowchart illustrating processing for supporting generation of a document.

FIG. 4 is a diagram illustrating an example of an input document.

FIG. 5 is a diagram illustrating an example of a word sequence to which a mask word is set.

FIG. 6 is a diagram illustrating an example of document possibilities.

### DESCRIPTION OF EMBODIMENTS

Hereinafter, embodiments of the present invention will be described with reference to the drawings. In the embodiments, a document generation supporting device that supports generation of a document by supporting an idea of a person to generate a new sentence will be described.

### Hardware Configuration of Document Generation Supporting Device

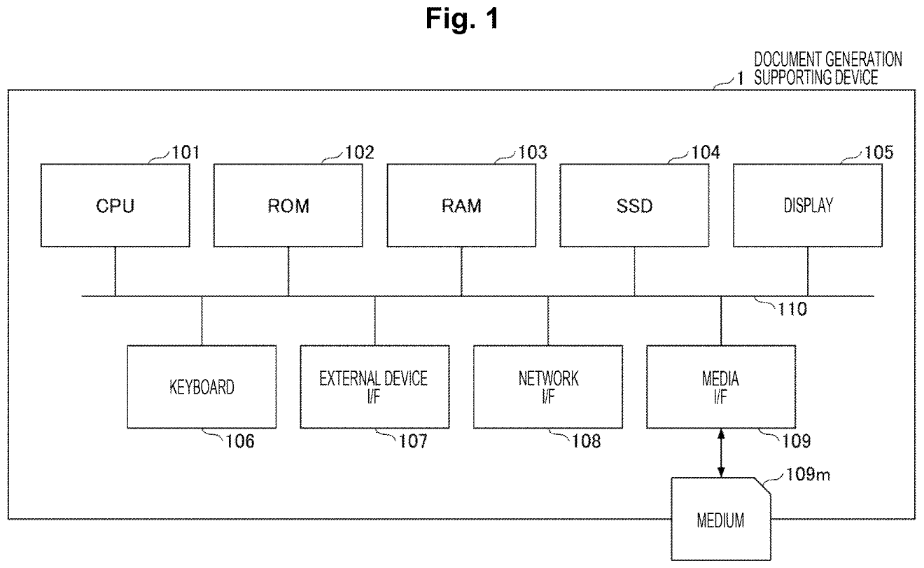

Next, an electrical hardware configuration of a document generation supporting device 1 will be described with reference to FIG. 1. FIG. 1 is an electrical hardware configuration diagram of a document generation supporting device according to the embodiment.

As illustrated in FIG. 1, the document generation supporting device 1 includes, as a personal computer (PC), a central processing unit (CPU) 101, a read-only memory (ROM) 102, a random access memory (RAM) 103, a solid state drive (SSD) 104, a display 105, a keyboard 106, an external device I/F 107, a network I/F 108, a media I/F 109, and a bus line 110.

Of these units, the CPU 101 controls an operation of the entire document generation supporting device 1. The ROM 102 stores a program such as an initial program loader (IPL) used for driving the CPU 101. The RAM 103 is used as a work area of the CPU 101.

The SSD 104 is a storage device that reads or writes various types of data such as a program of the document generation supporting device 1 under the control of the CPU 101. Instead of the SSD, a storage device such as a hard disk drive (HDD) may be used.

The display 105 is a type of display means such as liquid crystal or organic electro luminescence (EL) that displays characters, images, and the like.

The keyboard 106 is a type of input means including a plurality of keys for inputting characters, numerical values, various instructions, and the like.

The external device I/F 107 is an interface connecting various external devices. Examples of the external device in this case include an externally attached display as an example of display means, a mouse, an external keyboard or microphone as an example of input means, a printer or speaker as an example of output means, and a Universal Serial Bus (USB) memory as an example of storage means.

The network I/F 108 is a circuit transmitting and receiving data and the like to and from another evaluation device via the Internet.

The media I/F 109 controls reading or writing (storing) of data from or in a recording medium 109m such as a flash memory. The recording medium 109m also includes a digital versatile disc (DVD) and a Blu-ray disc (registered trademark).

The bus line 110 is an address bus, a data bus, or the like for electrically connecting each component such as the CPU 101 illustrated in FIG. 1.

### Functional Configuration of Document Generation Supporting Device

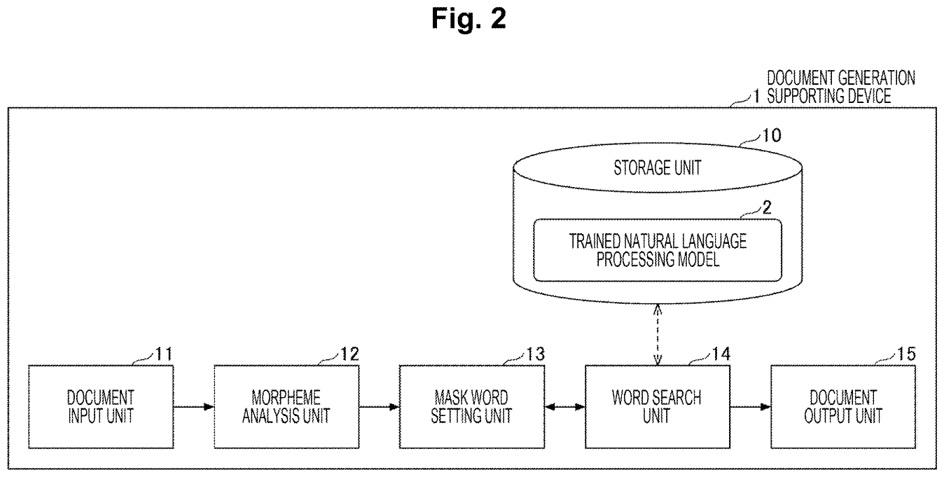

Next, a functional configuration of the document generation supporting device 1 will be described with reference to FIG. 2. FIG. 2 is a functional block diagram illustrating the document generation supporting device according to the embodiment. As illustrated in FIG. 2, the document generation supporting device 1 includes a storage unit 10. The storage unit 10 is implemented by the RAM 103 or the SSD 104 in FIG. 1.

The document generation supporting device 1 includes a document input unit 11, a morpheme analysis unit 12, a mask word setting unit 13, a word search unit 14, and a document output unit 15. Each of these units is a function implemented by a command by the CPU 101 in FIG. 1 based on a program.

Of these units, the document input unit 11 receives an input of data of a predetermined document from a user or the like.

The morpheme analysis unit 12 performs morpheme analysis on the data of the document input by the document input unit 11 and divides the document into words.

The mask word setting unit 13 generates a word sequence by setting a mask word by masking a predetermined word among the words divided by the morpheme analysis unit 12.

The word search unit 14 uses the trained natural language processing model to search for a likelihood in consideration of a word possibility and a context (before and after the word) based on the mask word (word sequence) set by the mask word setting unit 13 and determines a substitute possibility for the mask word in accordance with the likelihood to complete a document possibility. The word search unit 14 determines a substitute possibility at a probability proportional to the likelihood, or selects a predetermined number of words having a high likelihood and randomly determines the substitute possibility from the selected words. Further, the word search unit 14 determines substitute possibilities word by word for a plurality of mask words. The trained natural language processing model performs machine learning using a known machine learning algorithm by a neural network. Here, a model appropriate for the field of the content of the input document is used.

The document output unit 15 sorts and outputs the document possibilities completed by the word search unit 14 based on an evaluation index. Examples of the type of output include a display output displayed on the display 105 of FIG. 1, a print output performed by a printer that is an external device via the external device I/F 107 of FIG. 1, and a transmission output performed to another device via the network I/F 108 of FIG. 1.

### Process or Operation According to Embodiment

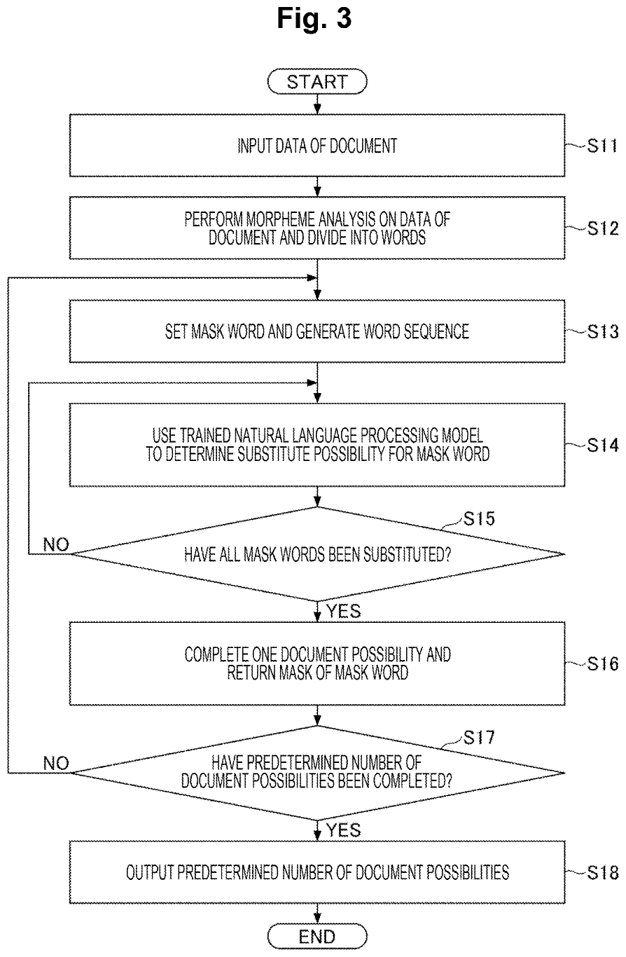

Next, processing or operation of the embodiment will be described in detail with reference to FIGS. 3 to 6. FIG. 3 is a flowchart illustrating processing for supporting generation of a document.

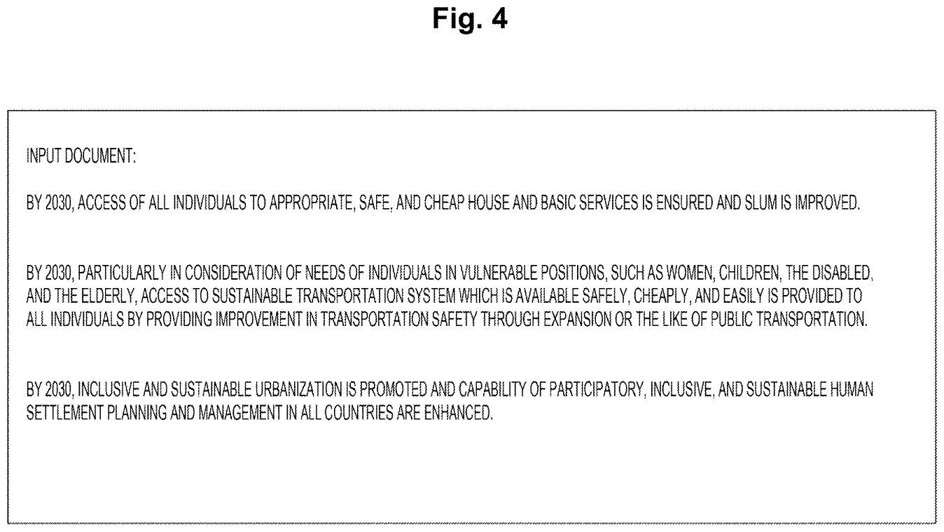

In FIG. 3, the document input unit 11 first inputs document data from a user (S11). FIG. 4 is a diagram illustrating an example of an input document. FIG. 4 illustrates a sentence describing content of sustainable development targets (SDGs).

Subsequently, the morpheme analysis unit 12 performs morpheme analysis on data of the document input by the document input unit 11 and divides the sentence into words (S12). Examples of the morpheme analysis method include MeCab, ChaSen, and KyTea.

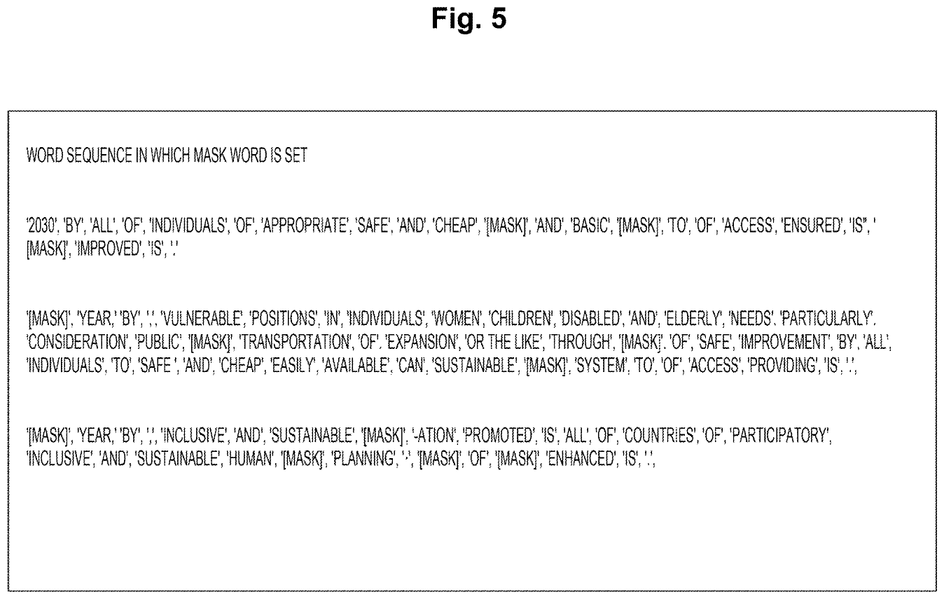

Subsequently, the mask word setting unit 13 selects a predetermined word among some all the words divided by the morpheme analysis unit 12, sets a mask word by masking the predetermined word, and generates a word sequence including each mask word (S 13). FIG. 5 is a diagram illustrating an example of a word sequence in which a mask word is set. Examples of a method of selecting a predetermined word include a method in which the mask word setting unit 13 evaluates and selects importance of the word by a known scheme such as tf-idf or an attention mechanism. The term frequency-inverse document frequency (tf-idf) is one of schemes of evaluating the importance of words included in a document, and is mainly used in fields such as information search and topic analysis. An attention mechanism is a mechanism that learns a relationship and a caution point for each element introduced to an Encoder-Decoder model mainly intended for machine translation, image processing, or the like. The user may manually select a predetermined word.

Subsequently, the word search unit 14 inputs the data of the word sequence to the trained natural language processing model pre-trained in accordance with a known scheme such as BERT, searches for a likelihood in consideration of a word possibility and a context (before and after the word), and stochastically determines a substitute possibility for the mask word in accordance with the likelihood (S14). Bidirectional Encoder Representations from Transformers (BERT) is a Transformer-based machine learning method for pre-learning of natural language processing (NLP). As “in accordance with the likelihood”, the substitute possibility (word) may be determined with a probability proportional to the likelihood, or a predetermined number of words having a high likelihood may be selected, and the substitute possibility (word) may be randomly determined from the selected words. In this case, the word search unit 14 determines the substitute possibility for each mask word word by word. The reason why the substitute possibility is determined word by word is that the possibility and likelihood for a subsequent mask word are changed when one substitute possibility is determined. The order of the words that the word search unit 14 substitutes may be from the beginning of the sentence or may be random.

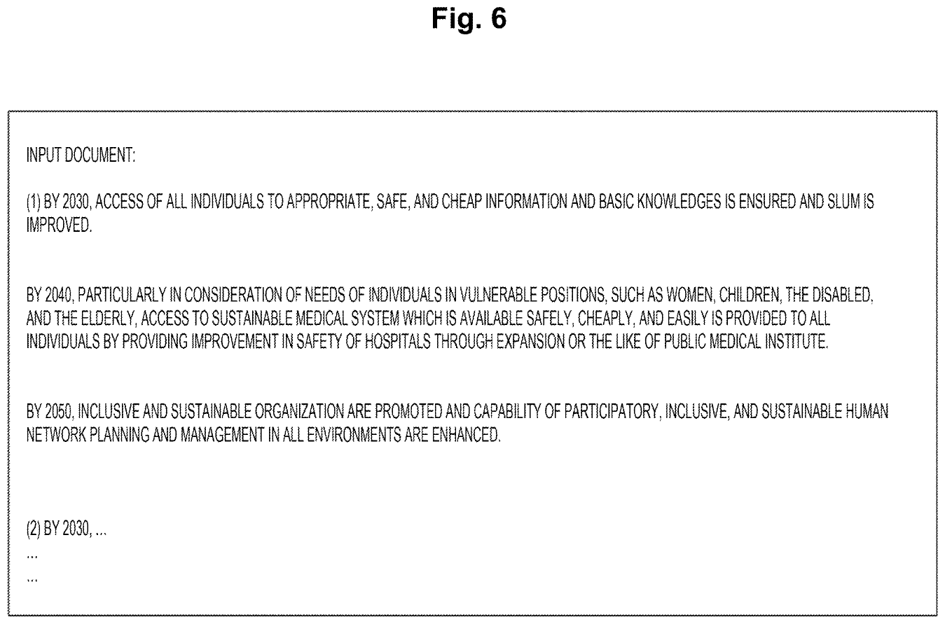

Subsequently, the mask word setting unit 13 determines whether all the mask words have been substituted (S15). If not all the mask words have been substituted (NO S15), the process returns to step S14. Conversely, when all of the components have been substituted (YES in S15), the mask word setting unit 13 completes one document possibility and returns (cancels) the mask of the mask word (S16). FIG. 6 is a diagram illustrating an example of a document possibility. In FIG. 6, a possibility for a first document is illustrated in (1), and a possibility for a second document is illustrated in (2).

Subsequently, the mask word setting unit 13 determines whether a predetermined number of document possibilities have been completed (S17). Then, when the predetermined number of sentence possibilities have not been completed (NO in S17), the processing returns to step S13. The predetermined number of document possibilities is preset by the user. Conversely, when the predetermined number of document possibilities have been completed (YES in S17), the document output unit 15 outputs and displays the predetermined number of document possibilities on the display 105 (S18). In this case, the document output unit 15 sorts the document candidates based on the evaluation indexes preset in advance by the user, and outputs and displays the sorted document candidates. Examples of the evaluation index include perplexity indicating prediction performance of the natural language processing model 2. The document output unit 15 may print and output the document candidates to a printer that is an external device via the external device I/F 107 in FIG. 1 or may transmit and output the document candidates to another device via the network I/F 108 of FIG. 1.

In addition to the documents illustrated in FIGS. 4 to 6, examples of documents that can be generated and supported by the document generation supporting device 1 include the following examples.
(1) Adaption of a recipe is supported by presenting another ingredient possibility instead of a word indicating an ingredient, a seasoning matching the ingredient, and the like using a known recipe sentence as an input.
(2) Generation of a new label is supported by inputting a known label.
(3) Generation of a future scenario is supported by using a future prediction scenario generated in the past as an input.

As described above, by performing fine-tuning on the trained natural language processing model 2 using sentences in the field, presentation of more appropriate words can be expected.

### Main Effects of Embodiment

As described above, according to the embodiment, the document generation supporting device 1 can support an idea of a person and generate a new document by using the trained natural language processing model 2 appropriate for a field of an input document and stochastically searching and presenting substitute possibilities for a word reflecting context before and after the word.

### Supplements

The present invention is not limited to the above-described embodiment, and the following configuration or processing (operation) may be used.

(1) The document generation supporting device 1 can also be implemented by a computer and a program. This program can be recorded on a recording medium or provided via the communication network 100.

(2) In the foregoing embodiment, a personal computer is described as an example of the document generation supporting device 1, but the present invention is not limited thereto. For example, a tablet terminal, a smartphone, a smartwatch, or the like may be used.

(3) The number of CPUs 101 is not limited to one, but may be plural.

### REFERENCE SIGNS LIST

1 Document generation supporting device
2 Trained natural language processing model
10 Storage unit
11 Document input unit (example of document input means)
12 Morpheme analysis unit (example of morpheme analysis means)
13 Mask word setting unit (example of mask word setting means)
14 Word searching unit (example of word search means)
15 Document output unit (example of document output means)

1. A document generation supporting device comprising:
a processor; and
a memory storing program instructions that cause the processor to:
perform morpheme analysis on data of a document and dividing the document into words;
set a mask word by masking a predetermined word among the divided words; and
use a trained natural language processing model to search for a likelihood in consideration of a word possibility and a context based on the mask word, and determine a substitute possibility for the mask word in accordance with the likelihood to complete a document possibility.

2. The document generation supporting device according to claim 1,
wherein the program instructions cause the processor to generate a word sequence by setting the mask word, and
wherein the program instructions cause the processor to search for the likelihood based on the generated word sequence using the trained natural language processing model.

3. The document generation supporting device according to claim 1, wherein the program instructions cause the processor to determine the substitute possibility at a probability proportional to the likelihood, or select a predetermined number of words having a high likelihood and randomly determine the substitute possibility from the selected words.

4. The document generation supporting device according to claim 1, wherein the program instructions cause the processor to determine the substitute possibility word by word for a plurality of the mask words.

5. The document generation supporting device according to claim 1, wherein the trained natural language processing model is bidirectional encoder representations from transformers.

6. The document generation supporting device according to claim 1, further comprising:
a document output means for sorting and outputting the plurality of document possibilities completed by the word search means based on an evaluation index.

7. A document generation supporting method comprising:
performing morpheme analysis on data of a document and dividing the document into words;
setting a mask word by masking a predetermined word among the divided words; and
using a trained natural language processing model to search for a likelihood in consideration of a word possibility and a context based on the mask word, and determining a substitute possibility for the mask word in accordance with the likelihood to complete a document possibility.

8. A non-transitory computer-readable recording medium having stored therein a program causing a computer to execute the method according to claim 7.
